(19) United States
(12) Patent Application Publication
(10) Pub. No.: US 2026/0265504 A1
(43) Pub. Date: Sep. 10, 2026

(54) ALGAL-BASED EXTRUDABLE FORMULATION, BIO-BASED AND COMPOSTABLE MATERIAL AND METHOD OF MANUFACTURING THEREOF

(71) Applicant: FLEXSEA LTD, London (GB)

(72) Inventors: Mattia Parati, London (GB); Thibaut Monfort-Micheo, London (GB); Carlo Fedeli, London (GB)

(21) Appl. No.: 19/162,396

(22) PCT Filed: Mar. 6, 2024
(86) PCT No.: PCT/IB2024/052160

§ 371 Date: Sep. 4, 2025

(30) Foreign Application Priority Data
Mar. 6, 2023 (GB) 2303278.2

(51) Int. Cl. C08L 5/00; C08J 3/20; C08K 5/053; C08L 67/04

(52) U.S. Cl. CPC C08L 5/00; C08J 3/201; C08K 5/053; C08L 67/04; C08J 2305/00; C08J 2367/04; C08J 2405/12; C08J 2467/04; C08L 2201/06; C08L 2205/025; C08L 2205/035; C08L 2205/06; C08L 2205/16

(57) ABSTRACT

Disclosed is an algal-based extrudable compostable formulation comprising: at least one hydrocolloid that is extracted from algae, wherein the at least one hydrocolloid is present in a range of 30% to 80% of a total weight of the algal-based extrudable compostable formulation; and at least one plasticizer, wherein the at least one plasticizer is present in a range of 20% to 70% of the total weight of the algal-based extrudable compostable formulation, wherein the algal-based extrudable compostable formulation comprises at least one biobased biodegradable polymer derived from at least one cultivated biomass, and wherein the at least one biobased biodegradable polymer is present in a range of 1% to 80% of a total weight of the algal-based extrudable compostable formulation; and wherein the algal-based extrudable compostable formulation comprises at least one biobased reactor-derived ingredient, wherein the at least one biobased reactor-derived ingredient is present in a range of 5% to 50% of a total weight of the algal-based extrudable compostable formulation, wherein the at least one biobased reactor-derived ingredient is at least a biosurfactant produced in a reactor.

### TECHNICAL FIELD

This invention relates to a formulation. In particular, though not exclusively, this invention relates to an algal-based extrudable compostable formulation, containing at least one biobased biodegradable polymer derived from a cultivated source of biomass and at least one biobased reactor-derived ingredient and a method of manufacturing such a biobased and compostable material.

### BACKGROUND

Synthetic polymers are ubiquitous across industrial fields. Synthetic polymers have been widely used for manufacturing of packaging, coverings, moulded products, bottles, containers, and the like. They are widely used as they are often easily shaped, have superior physicochemical properties, and are economical. However, these materials cannot be degraded after use via natural biochemical pathways and have high sustainability cost. Bioplastics encompasses a wide range of materials, in part due to not being clearly defined and having an incomplete regulatory framework. As such, “bio” could refer to biobased feedstock, notwithstanding any chemical transformation of it, further chemical bonding of it within a matrix or to itself (directly or via molecular bridge) or refer to the biodegradability of the material, notwithstanding the conditions of such degradation. Further, there are few biobased synthetic polymers that are industrially compostable, however, such polymers pose various hurdles such, for example, longer decomposition time, non-availability of industrial conditions in Nature for a sustainable degradation outside of the waste-collection and handling streams, higher cost, limited recycling options, or similar. Moreover, the processing of biobased synthetic polymers that are home compostable has also posed huge hurdles in terms of sourcing, processing temperatures, degradation of raw materials and the reprocessing of extruded material to form usable products. Further, materials manufactured using the biobased synthetic polymers pose various challenges to the environment. For example, bottles manufactured using petroleum-based plastics and biobased synthetic polymers, such as Poly lactic acid (PLA), modified starches, cellulose acetate can only be degraded in industrial composting facilities at high temperatures such as more than 58 degrees Celsius, in compliance with the EN 13432 industrial composability law or the ASTM D6400. The aforesaid temperature required for degradation of the PLA is not feasible to achieve naturally as briefly mentioned above. Furthermore, the biobased synthetic polymers are chemically polymerized and are not environmentally friendly. On the other end of the spectrum, there are also synthetic materials that are fossil fuel derived and have good end-of-life in natural environments-so called ‘home-compostability’ but are not sustainably sourced. Examples of such materials include: PBAT, PBSA and PBST (although partially biobased), ethylene vinyl acetate (EVA), polyvinyl alcohol (PVOH), polycaprolactone (PCL) or similar. PBS for instance rides in between those but with similar issues due to its industrial compostability and only-partial biobased content. Therefore, there is a need to find an alternative to the petroleum based plastic and biobased synthetic polymers as the processing of such material may have detrimental impact on the environment such as the emission of high amounts of greenhouse gases (GHGs), negative impact on wildlife and may impart several health complications related to microplastic and/or nano plastics as well as causing issues relating to the leakage of additives within petroleum derived plastics.

The Polyhydroxyalkanoates (PHAs) currently produced through microbial cultivation are typically obtained from genetically engineered or recombinant microorganisms, presenting certain challenges. However, it is noteworthy that not all PHAs are derived from such engineered sources. Additionally, while a limited number of PHA producers have succeeded in scaling up production using waste fractions such as waste frying oils, the primary raw materials for the PHA production remain cultivated products or byproducts, such as sugars or oils.

A significant distinction from the aforementioned polymers lies in the natural, non-synthetic polymerization process of the PHAs. These polymers undergo metabolism by microorganisms in a natural environment, and the efficiency of this metabolic process is enhanced by carefully controlling the cultivar, biomass source, and cultivation conditions: as they would in a greenhouse for high-yielding cultivation of fruits and vegetables. The PHAs exhibit home compostability under natural conditions, setting them apart from other synthetic polymers (for example PP or BioPP), or bioderived, synthetically polymerized, industrially compostable materials (for example PLA); and exhibits good water-resistance properties, although more limited barriers to oxygen and lipids.

Further, as alternatives to synthetic polymers, biodegradable polymers have also been used. However, the processing of conventional biodegradable polymers poses certain challenges in terms of their casting, extrusion, thermochemical processing or similar.

The PHAs are recognized for their limited processing windows and crystallisation kinetics-process which allows handling of the material in a non-melt form, a characteristic that often necessitates the incorporation of nucleating agents, antioxidants, slipping agents, plasticisers or other additives which can, but usually aren't, be synthetic and/or environmentally harmful. This is particularly evident in the transition from the powder produced by microorganisms to the pellet form suitable for extrusion. While the effectiveness of this process in maintaining stability during processing is subject to assessment, it serves to highlight the challenges associated with the conventional use of the PHAs. Notably, the PHAs can be extracted from microorganisms through enzymatic, and mechanical methods, thus favoring solventless production of material which significantly improves the life cycle (and sustainability) of the material.

The existing biobased biodegradable polymer, from but not limited to the list above, requires extra care to become compatible with the seaweed matrix (monitoring and tuning of respective hydrophilicity, charge, viscosity, Hilderbrand solubility parameters, melting/softening temperatures, and so forth). Further, the end properties of the biodegradable polymers do not always meet market needs which leads to petroleum-based bioplastics overperforming such biodegradable polymers. As an example, Poly lactic acid (PLA) is a bioderived, chemically polymerised biodegradable polymer. Although PLA is biodegradable, it is not currently as sustainable as it could be as it emits approximately 1.3 kg CO₂ equivalents/kg of synthesised plastic, as well as the fact that producing it and refining it depends on unsustainable practices requiring the use of arable land, water, pesticides and fertilizers. That coupled to the infinitesimal collection of industrially compostable waste, meaning that similar-degradation-conditioned materials often end up incinerated of left to fragment in long-lasting microplastics when leached in the environment (up to 70% when combining landfill and lost in nature). This means that overall, due to its lack of natural condition degradability, the PLA does not fall within a circular economy with regards to sustainability and exemplifies the challenges of creating a truly carbon neutral material which is also biodegradable or compostable. it is practically impossible to create the biobased synthetic polymers which are free of any carbon emissions, however this may lead to severe negative impact with regards to health issues, microplastic pollution, negative impacts on ecosystems, and similar. Further, sustainability of the PLA can be enhanced by blending it with natural materials such as coconut coir fibres, or with natural derived fibres that are also chemically modified fibres (i.e. carboxymethyl cellulose or cellulose acetate), however, such practices limit processability and/or scalability of the biodegradable polymers, as the processability of biobased materials is limited by the intrinsic fragility and properties of the biobased feedstock.

Additionally, the behavior of natural polymers when subjected to processing, leads to a modification in their degradation profile. For instance, the conversion of natural starch, when formulated with other components and transformed into thermoplastic starch, results in a material that is primarily industrially compostable and loses its home compostable characteristics. Moreover, due to their intrinsic hygroscopic behavior, from the presence of many hydroxyl groups on the backbone, polysaccharides tend to attract a lot of water in their matrix when formulated in (pseudo-)thermoplastic resins, which spaces out the chains and makes the bulk less rigid (decrease in crystallinity of the structure). In order to avoid this, chemical modification of the polysaccharides can occur to increase hydrophobicity of the material, this includes oxidation, esterification, epoxidation, vinylation or branches and backbones, but also the introduction of covalent cross-links with or without bridge molecules (such as maleic anhydride, commonly used for PLA, or citric acid). This also allows a stronger hold of the matrix and less water absorption; but may also limit degradation thermodynamics and kinetics. Although these practices bridge the gap between the performance required by the industry and the characteristics achieved through bioderived materials; all of these practices limit extensively their use due to the lack of infrastructure to properly deal with this non-recyclable, poorly degradable material.

Moreover, it is imperative to recognize that naturally occurring polysaccharides or analogous substances lack inherent rigidity (due to their abundant hydroxyl groups that strongly induce absorption of water from the air, which is a great plasticizers from the mechanism of inter-chain distance increase as cited above), posing a significant challenge to the industry seeking alternatives to materials like PP, PET, and HDPE.

Therefore, in light of the foregoing discussion, there exists a need to overcome the aforementioned drawbacks related with conventional polymers.

### SUMMARY OF THE INVENTION

A first aspect of the invention provides an algal-based extrudable compostable formulation comprising:
at least one hydrocolloid that is extracted from algae, wherein the at least one hydrocolloid is present in a range of 30% to 80% of a total weight of the algal-based extrudable compostable formulation;
at least one plasticizer, wherein the at least one plasticizer is present in a range of 20% to 70% of the total weight of the algal-based extrudable compostable formulation;
at least one biobased biodegradable polymer, wherein the at least one biobased biodegradable polymer is derived from at least one cultivated biomass, and wherein the at least one biobased biodegradable polymer is present in a range of 5% to 80% of a total weight of the algal-based extrudable compostable formulation; and
at least one biobased reactor-derived ingredient, wherein the at least one biobased reactor-derived ingredient is present in a range of 5% to 50% of a total weight of the algal-based extrudable compostable formulation,
   wherein the at least one biobased reactor-derived ingredient is at least a biosurfactant produced in a reactor.

In this regard, the “algae” comprises seaweed (macroalgae), and microalgae. The algae are a diverse group of prokaryotic and eukaryotic aquatic organisms. The microalgae and the seaweed have the ability to metabolize hydrocolloids either as structural polymers or as a form of storage (such as. starch). As an example, the at least one hydrocolloid may be sustainably metabolized by the macroalgae as a structural polymer such as agar or cellulose. It will be appreciated that the at least one hydrocolloid is neither produced by fermentation of the algae nor by chemical modification of the algae. The at least one hydrocolloid may be sustainably and naturally metabolized from the seaweed. In an example, to obtain the at least one hydrocolloid, the seaweed may be washed in an alkaline solution. In the case of Euchema spp. species, this process has for effect to convert respectively the mu-carrageenan in kappa-carrageenan (in Euchema Cottoni), and nu-carrageenan in iota-carrageenan (in Euchema Spinosum/Denticulatum). However, the process of mu and nu to kappa and iota is also naturally occurring, hence by most international definitions, it is agreed that the alkali process is not counted as the one making a ‘chemically modified polymer’. Further, the seaweed may be washed in an acidic solution and post washing in the acidic solution, the seaweed may be washed in a neutral solution. Post washing, the seaweed may be milled to obtain a seaweed flour. Alternatively, the seaweed washed in the neutral solution may be extracted and allowed to precipitate and filtered to obtain the at least one hydrocolloid. Optionally, the at least one hydrocolloid is extracted through a mechanical action, an enzymatic action, a microwave process, and so forth.

The macroalgae could be red macroalgae, brown macroalgae, and green macroalgae. Examples of the red macroalgae could be Eucheuma Cottonii (aka Kappaphycus Alvarezii), Euchema Spinosum, Gracilaria spp, and Gelidium spp. Examples of the brown macroalgae include, Undaria spp., Laminaria digitata, Alaria esculenta, Saccharina latissima, Sargassum spp., Ascophyllum nodosum, or similar. Examples of the green macroalgae include Ulva spp.

The at least one hydrocolloid is present in a range of 30% to 40%, 30% to 60%, 30% to 80%, 35% to 60%, 35% to 80%, 50% to 60%, 50% to 70%, 50% to 75%, 50% to 80%, 55% to 60%, 55% to 75%, 55% to 80%, 60% to 70%, 60% to 75%, 60% to 80%, 70% to 75%, 70% to 80% of the total weight of the algal-based extrudable compostable formulation. Beneficially, the aforementioned range of the at least one hydrocolloid allows tuning of hygroscopicity (water absorption) of the algal-based extrudable compostable formulation. Moreover, the hygroscopicity of the algal-based extrudable compostable formulation contributes to accelerated biodegradation thereof for applications which need quicker degradation times. Furthermore, the hygroscopicity of the algal-based extrudable compostable formulation allows tuning of the rigidity/flexibility of final products produced from the algal-based extrudable compostable formulation. Specifically, higher concentration of the at least one hydrocolloid provides more flexibility to the final products produced from the algal-based extrudable compostable formulation, thus increasing the range of application thereof across various industries.

Examples of the at least one hydrocolloid include, agar, kappa-carrageenan, iota-carrageenan, lambda-carrageenan, fucoidan, alginate, porphyrin, ulvan, Laminarin or similar. The at least one hydrocolloid is biodegradable and has mechanical properties, as well as potential for interchain reactions. Notably, their behavior under heat is distinct from that of conventional thermoplastics, as the aforementioned blends are malleable solids which are processed under heat and shear past their complex glass transition profile as they do not present a melting point due to the differences in crystallinity between thermoplastics versus amorphous hydrocolloids. In this regard “biodegradable” refers to a substance that is capable of being broken down, especially into innocuous products (CO₂, H₂O and biomass), by bacteria or other living organisms in order to avoid pollution or negative environmental effects as per standards such as EN 14855 and/or OECD 301B. In an implementation, the algal-based extrudable compostable formulation may comprise one hydrocolloid present in the aforesaid range. In said implementation, the algal-based extrudable compostable formulation may comprise only agar as the at least one hydrocolloid. In another implementation, the algal-based extrudable compostable formulation comprises a mixture of various hydrocolloids. In said implementation, the algal-based extrudable compostable formulation may comprise a mixture of the agar and kappa-carrageenan.

Optionally, the algal-based extrudable compostable formulation comprises intact, unprocessed algae containing one of the at least one hydrocolloid in the aforesaid range. Optionally, the unprocessed algae are used in a form of flour. Optionally, the particle size of the material is below 600 microns, optionally below 200 microns for the optimal performance/interaction/blending of the components within the compounding. Examples of the unprocessed algae include, but are not limited to, red algae, brown algae, green algae.

The “plasticizer” is an additive material that is added to the at least one hydrocolloid to impart required flexibility and processability to the at least one hydrocolloid. Optionally, if a given plasticizer type is not added at the perfect amount within the matrix, depending on the other components, this fraction is pushed out of the matrix preventing its use in the industry. Optionally, a hydrophilic or an amphiphilic plasticizers is used to accommodate the bioplastic fraction in the matrix (i.e. glycerol trioctanoate or triacatate, or tweens or atmers or stearates). Optionally, the at least one plasticizer is present in a range of 20% to 35%, 20% to 50%, 20% to 70%, 30% to 35%, 30% to 50%, 30% to 70%, 50% to 70%. Examples of the at least one plasticizer include, polyol, sugar, urea, water, thermoplastic, thermoplastic derived compound and the like. Examples of the polyol include, but are not limited to, sorbitol, xylitol, glycerol, polyglycerols. Examples of the sugar include, but are not limited to, simple sugar, sucrose, esters of sugar and eutectic mixture thereof. Notably, the aforementioned at least one thermoplastic or thermoplastic derived compound is used to create a flowing matrix to support the at least one hydrocolloid and allow processability in a flowing state, as opposed to the powder form of the at least one hydrocolloid. In this instance the at least one thermoplastic or thermoplastic derived compound is unconventionally used for its flowing ability at processing temperatures which enables the transformation of the end product into a compact solid. Optionally, the at least one hydrocolloid and the at least one plasticizer are added in a ratio of 2:1. Optionally, the at least one hydrocolloid and the at least one plasticizer are added in a ratio of 1:8 in the algal-based extrudable compostable formulation. Optionally, the at least one plasticizer is present in a form of any one of: a liquid, powder. The at least one plasticizer is mixed with the at least one hydrocolloid to enhance mouldability and flexibility of the at least one hydrocolloid. Further, the at least one plasticizer reduces the melting temperature of the blend containing the at least one hydrocolloid below their decomposition temperature so as to facilitate plasticization of the algal-based extrudable compostable formulation.

Optionally, the at least one hydrocolloid comprises agar and carrageenan mixed in a ratio of 1:2, respectively. In this regard, optionally, the carrageenan is at least one of: the iota-carrageenan, lambda-carrageenan and kappa-carrageenan. Optionally, the agar and the carrageenan are mixed using a vessel with the at least on plasticizer in order to create a slurry which is then added to an extruder.

Optionally, the agar and carrageenan are mixed at a temperature of 45 degrees Celsius to 90 degrees Celsius.

Optionally, the at least one plasticizer comprises a composition of glycerol, water and polyglycerols, wherein glycerol comprises 0.1 to 10% of the plasticizer composition. In this regard, the polyglycerol, water and the glycerol are mixed manually. Optionally, the polyglycerol, water and glycerol are mixed using an industrial stirring vessel. Optionally, the polyglycerol, water and the glycerol are mixed at a temperature of 20 degrees Celsius to 90 degrees Celsius. Optionally, mixing of the polyglycerol, water and the glycerol results in enhanced physicochemical properties of products manufactured using the algal-based extrudable compostable formulation.

Moreover, the algal-based extrudable compostable formulation comprises at least one biobased biodegradable polymer. Moreover, the at least one biobased biodegradable polymer is derived from at least one cultivated biomass. The at least one cultivated biomass include cultivated weeds, in wild waters, ponds, offshore, but also terrestrial cultivated. The term “cultivation” as used herein refers to a controlled growth of living organisms, such as plants, algae, fungi, and bacteria, for the purpose of harvesting their biomass or derived products. The cultivation allows for precise control over environmental factors like temperature, light, and nutrient availability, leading to consistent and optimized production. Optionally, the cultivation is a natural cultivation that involves growing organisms in their natural habitats, such as seaweed farms or land-based crop cultivation. While scalable for some biomasses, natural environments are subject to unpredictable fluctuations and limitations. Optionally the at least one biobased biodegradable polymer can be partly derived from a non-cultivated source such as invasive species, waste agri-food fractions and wild harvesting.

Beneficially, the at least one cultivated biomass provides scalability, repeatability, consistency, tuning of properties, yield, and traceability. Preferably, the at least one fraction is a seaweed biomass that offers a high content of valuable hydrocolloids and minimizes land-use requirements. Optionally, the at least one fraction is a bacterial biomass that enables efficient production of storage and secreted polymers with diverse applications. Optionally, the at least one fraction is a derived storage and secreted polymers that offer a sustainable alternative to fossil fuel-derived plastics and can be tailored for specific functionalities.

Genetic modification, a revolutionary technique in biotechnology, plays a pivotal role in enhancing agricultural yields and exerting precise control over material output. By manipulating the genetic makeup of organisms, particularly plants, scientists can introduce beneficial traits that contribute to increased crop productivity. This targeted approach allows for the modification of specific characteristics such as resistance to pests, tolerance to environmental stressors, and improvements in nutrient utilization. Moreover, the genetic modification enables the fine-tuning of material properties and chemical functionalities in crops. This precision is invaluable for tailoring crops to meet specific industrial or consumer needs, ensuring consistency in quality, and enhancing the overall efficiency of agricultural processes.

Moreover, the algal-based extrudable compostable formulation comprises at least one biobased biodegradable polymer in a range of 5% to 80% of the total weight of the algal-based extrudable compostable formulation. In this regard, the at least one biobased biodegradable polymer are biologically derived polymers. Optionally, the at least one biobased biodegradable polymer is present in a range of 5% to 15%, 5% to 30%, 5% to 35%, 5% to 40%, 5% to 50%, 5% to 60%, 5% to 70%, 5% to 80%, 10% to 15%, 10% to 30%, 10% to 35%, 10% to 40%, 10% to 50%, 10% to 60%, 10% to 70%, 10% to 80%, 20% to 30%, 20% to 35%, 20% to 40%, 20% to 50%, 20% to 60%, 20% to 70%, 20% to 80%, 30% to 40%, 30% to 50%, 30% to 60%, 30% to 70%, 30% to 80%, 40% to 50%, 40% to 60%, 40% to 70%, 40% to 80%, 50% to 60%, 50% to 70%, 50% to 80%, 60% to 70%, 60% to 80%, 70% to 80%. Typically, the at least one biobased biodegradable polymer comprise polylactic acid (PLA), and polyhydroxyalkanaotaes (PHAs), polybutylene succinate (PBS), or different starch blends. Examples of the at least one bio based polymer include, but are not limited to, thermoplastic starch, DL-polylactide (DLPLA), D-polylactide (DPLA), L-polylactide (LPLA), polyglycolide (PGA), poly(DL-lactide-co-glycolide) (PGLA), poly (trimethylene carbonate), polyglyconate (e.g., a copolymer of glycolide and trimethylene carbonate), polyhydroxyal kanoates (PHA), polyhydroxybutyrate (PHB), polyhydroxybutyrate-co-hydroxyvalerate (PHBV), polyhydroxyvalerate (PHV), polyhydroxybutyrate-co-hexanoate (PHBHH), polyhydroxyvalerate-co-hexanoate (PHVHH), polysaccharides (e.g., homopolysaccharides and heteropolysaccharides), modified polysaccharides such as cellulose acetate and chitosan, poly(1,4-butylene succinate) (PBS), poly(butylene succinate adipate) (PBSA) polyanhydrides such as poly(sebacic acid-co-hexadecandioic acid anhydride), poly(ethylene 2,5-furandicarboxylate) (PEF), thermoplastic starch (TPS) and modified starches, starch-based aliphatic polyesters, polyesteramides (PEA), natural fibers such as starch and cellulose. Optionally, the at least one biobased biodegradable polymer has enhanced compatibility with the mixture containing the at least one hydrocolloid, as well as improved barrier and mechanical properties. The at least one biobased biodegradable polymer is derived from cultivated biomass, or directly cultivated using biobased media, before being added to the algal-based extrudable compostable formulation. The derivation of the at least one biobased biodegradable polymer results in the biodegradability and extrudability of the algal-based extrudable compostable formulation to be further enhanced, including, but not limited MFI, thermoplastic-like behaviour, reprocessability, water barrier and strength, resulting in usability of the algal-based extrudable compostable formulation for a variety of applications. It will be appreciated that the cultivation process of the biomass from which the at least one biobased biodegradable polymer is derived from introduces a layer of specificity and control in the production of the at least one biobased biodegradable polymer, allowing for precise adjustments in its properties and composition, further enabling higher performance, application-specific materials capable of displacing current alternatives. Optionally the biobased polymer is obtained through the cultivation of a microorganism aerobically.

Optionally, the at least one biobased biodegradable polymer derived from at least one cultivated biomass can be metabolised by the plants or by the microbes in the form of storage or structure. Optionally, the derivation can be a cultivation process happening in a fermenter with a biobased cultivation media. Optionally, the at least one other non-chemically polymerized biobased biodegradable polymer present in the range of 1 to 25% of the total weight of the algal-based extrudable compostable formulation. Optionally, the seaweed based material especially in reprocessing is a pseudo thermoplastic with limited melt flow behaviour, hence the small addition of high molecular weight thermoplastic biobased biodegradable polymer can increase melt flow properties (such as melt flow index, viscosity) for further part production. Optionally, the at least one cultivated biomass or its extracts can be chemically modified to enhance properties, provided it keeps it home and industrial compostability and it is of minimal negative impact to the environment. Said chemical modification makes it energy efficient and cost efficient.

Beneficially, the biobased biodegradable polymer derived from renewable biological sources such as plants, animals, or microorganisms and not synthesized or derived from petroleum-based sources offers several benefits. For example, the biobased biodegradable polymers reduce reliance on finite fossil fuel resources and supports sustainable practices as they have a lower carbon footprint compared to petroleum-based counterparts. They typically require less energy and produce fewer greenhouse gas emissions during production. Additionally, the biobased biodegradable polymers naturally decompose into harmless byproducts through biological processes, such as microbial action or enzymatic degradation. Thereby, reducing the accumulation of waste in landfills and the environment, mitigating pollution and littering issues. Moreover, the biobased biodegradable polymers produce non-toxic decomposition products, and become a part of closed-loop systems where waste is recycled back into the production process, thus reduce resource consumption and waste generation. Optionally, the algal-based extrudable compostable formulation further comprises at least one non-biobased biodegradable polymer in a range of 1% to 7.5% of the total weight of the algal-based extrudable compostable formulation. In this regard, the at least one non-biobased biodegradable polymer is synthetically derived and can be easily degraded in industries and/or in homes. Optionally, the at least one non-biobased biodegradable polymer is present in a range of 1% to 2.5%, 1% to 3.5%, 1% to 4.5%, 1% to 5.5%, 1% to 6.5%, 1% to 7.5%, 2.5% to 3.5%, 2.5% to 4.5%, 2.5% to 5.5%, 2.5% to 6.5%, 2.5% to 7.5%, 3.5% to 4.5%, 3.5% to 5.5%, 3.5% to 6.5%, 3.5% to 7.5%, 4.5% to 5.5%, 4.5% to 6.5%, 4.5% to 7.5%, 5.5% to 6.5%, 5.5% to 7.5%, 6.5% to 7.5%. Examples of the at least one non-biobased polymer include, but are not limited to, poly(dioxanon) (PDO), poly(1,4-butylene adipate) (PBA), poly butadiene adipate co-terephthalate polymer (PBAT), poly(caprolactone) (PCL). Beneficially, the non-biobased biodegradable polymers can be used as additives in order to help the rheology and melt behaviour of the material whilst maintaining the home and industrial compostability of the resulting algal-based formulation.

Optionally, the algal-based extrudable compostable formulation further comprises biomass in a range of 1% to 35% of the total weight of the algal-based extrudable compostable formulation. In this regard, the biomass is present in a range of 1% to 10%, 1% to 25%, 1% to 35%, 5% to 10%, 5% to 25%, 5% to 35%, 15% to 25%, 15% to 35%. Examples of the biomass include, but are not limited to, bacterial biomass, pre-extraction algal biomass, post-extraction biomass, yeast biomass, industrial by-products. Optionally, the algal biomass is at least one of: raw algal biomass, hydrocolloid extracted algal biomass. Examples of the industrial by-products include, but are not limited to, brewery spent grain, food waste, compost, post process biomass from food and beverages processes. The industrial by-products are rich in protein and fibers which leads to an increase in strength of the resulting product of the algal-based extrudable compostable formulation. The biomass may be added in the form of a powder. Optionally, the biomass is added to the algal-based extrudable compostable formulation to impart natural coloration as well as enhancing extrudable properties. Advantageously, the technical benefit of adding the biomass to the algal-based extrudable compostable formulation is that scalability, life-cycle sustainability and cost-effectiveness for processing the algal-based extrudable compostable formulation is significantly improved. Moreover, addition of the biomass beneficially leads to fertilizer effect.

Optionally, the at least one biobased biodegradable polymer is poly(1,4-butylene succinate) (PBS) in a range of 5% to 20% of the total weight of the algal-based extrudable compostable formulation. In this regard, optionally, the PBS is present in a range of 5% to 8%, 5% to 12%, 5% to 15%, 7% to 12%, 7% to 15%, 10% to 12%, 10% to 15%, 10% to 20%, 15% to 20%. Optionally, the PBS is synthesized from biobased materials. The PBS has high tensile strength and stiffness, acts as a water barrier, and possesses high biodegradability. Advantageously, the technical effect of using the PBS is that it can be tuned to have enhanced oxygen barrier properties upon mixing with other constituents of the algal-based extrudable compostable formulation and owing to its aforesaid properties, usability of the algal-based extrudable compostable formulation can be significantly improved.

Optionally, the at least one biobased biodegradable polymer is a polyhydroxyalkanoate family of polymers (PHA's) in a range of 2% to 35% of the total weight of the algal-based extrudable compostable formulation. In this regard, optionally, the PHA is present in a range of 2% to 5%, 2% to 10%, 2% to 15%, 5% to 10%, 5% to 15%, 5% to 25%, 5% to 30%, 5% to 35%, 10% to 15%, 10% to 25%, 10% to 30%, 10% to 35%, 15% to 30%, 15% to 35%. Optionally, the polyhydroxyalkanoate PHA polymer family is in a range of 50% to 75% of the total weight of the algal-based extrudable compostable formulation. In this regard, optionally, the PHA is present in a range of 50, 55, 60, 65 or 70% up to 55, 60, 65, 70 or 75%. The PHA is a biodegradable and home compostable polyester and is used to form polymer blends. The PHA may undergo degradation in a few weeks and can be processed through extrusion to obtain rigid or flexible parts with good mechanical properties and water barrier properties. Advantageously, the technical effect of using the PHA is that the algal-based extrudable compostable formulation can be effectively used to form rigid parts for packaging. The PHA is home compost and derived from bacterial metabolism, PBS is partially bio based but industrial compost, while the PBSA and the PHA are home compost.

Furthermore, the algal-based extrudable compostable formulation comprises at least one biobased reactor-derived ingredient. In this regard, a “biobased reactor-derived ingredient” means an ingredient created in a reactor using at least one biobased material. Optionally, the at least one biobased reactor-derived ingredient is present in a range of 5% to 10%, 5% to 15%, 5% to 20%, 5% to 25%, 5% to 30%, 5% to 40%, 5% to 50%, 10% to 15%, 10% to 20%, 10% to 25%, 10% to 30%, 10% to 40%, 10% to 50%, 15% to 20%, 15% to 25%, 15% to 30%, 15% to 40%, 15% to 50%, 20% to 25%, 20% to 30%, 20% to 40%, 20% to 50%, 25% to 30%, 25% to 40%, 25% to 50%, 30% to 40%, 30% to 50%, 40% to 50%. Herein, the reactor refers to an apparatus or structure or container or vessel in which biobased material can be made to undergo a controlled, chemical or biological reaction with the consequent formation of a product which, in its simplest form sees multiple connected starting units joined by covalent bonds. Examples of the reactor-derived ingredients include biobased ingredients such as biobased solvents, functional additives, and more, all meticulously crafted within the controlled environment of a reactor. Benefits of the reactor-derived ingredients include scalability, yield optimization, quality and purity control, impact on sustainability.

Moreover, the at least one biobased reactor-derived ingredient is a biosurfactant. Notably, waste substrates (such as whey, molasses, potato and cassava wastewater, flying oil, corn steep liquor, refinery oil waste, and so forth) when combined with water and supplemented with essential nutrients (such as vitamins, minerals, and trace elements) to support microbial growth in a reactor results in biosurfactant production. Moreover, the reactor is supplied with optimal fermentation conditions, including pH, temperature, aeration, and agitation, to optimize biosurfactant production while minimizing by-products and ensuring microbial viability. It may be appreciated that choice substrate, fermentation conditions and specific strain of microorganism can determine the type of biosurfactant produced. The application of biosurfactants in biopolymer production offers several advantages, including environmental sustainability, reduced toxicity, and compatibility with green manufacturing processes.

Optionally, the biosurfactant is selected from any one of: lipopeptide, sophorolipids, glycolipid, produced by means of the reactor. Notably, lipopeptide, sophorolipids, and glycolipid possess unique surface-active properties and are eco-friendly in nature. In an example, lipopeptides may be produced from whey, molasses, potato and cassava wastewater in presence of Bacillus sp. and Starmerella bombicola NBRC 10243.

Notably, lipopeptide biosurfactants are produced by various bacteria, notably Bacillus species. Lipopeptides exhibit strong surface tension reduction, antimicrobial properties, and potential applications in agriculture, pharmaceuticals, and cosmetics. In biopolymer production, lipopeptides can serve as surfactants in the fermentation process, enhancing the production of biopolymers such as polyhydroxyalkanoates (PHAs) or biodegradable plastics. Examples of lipopeptides include surfactin, iturin, and fengycin. Surfactin has strong surface activity, leading to excellent emulsifying, foaming, and wetting properties. Surfactin also exhibits antimicrobial activity against a wide range of pathogens, making it valuable in applications such as bioremediation, food preservation, and pharmaceuticals. In biopolymer production, surfactin can enhance the production of various biopolymers, including PHAs, by improving nutrient uptake and microbial fermentation efficiency. Iturin has potent antifungal activity and is known for its ability to suppress plant pathogens, making it valuable in agriculture as a biocontrol agent. Iturin also exhibits surfactant properties, contributing to its ability to form stable emulsions. In biopolymer production, iturin can potentially enhance the synthesis of biopolymers by promoting the growth of microbial producers and protecting them from fungal contamination. Fengycin is a cyclic lipopeptide that exhibits strong antifungal activity. Fengycin can function as anticancer agent due to its ability to induce apoptosis in certain cancer cell lines. In biopolymer production, fengycin may play a role in enhancing microbial fermentation processes by improving cell viability and productivity.

Notably, sophorolipids are glycolipid biosurfactants produced mainly by yeast species, that have excellent emulsifying properties and are biodegradable. In biopolymer production, sophorolipids can act as efficient emulsifiers or stabilizers, aiding in the synthesis of biodegradable polymers like polyhydroxyalkanoates (PHAs) or even in the formulation of nanocomposites. In an example, sophorolipids may be produced from molasses in presence of Starmerella bombicola NBRC 10243.

Notably, glycolipid biosurfactants are produced by a range of microorganisms, including bacteria, yeasts, and fungi. Examples of glycolipid include rhamnolipids and trehalolipids. Glycolipids have excellent emulsifying capabilities, low toxicity, and biodegradability, making them attractive for various applications. In biopolymer production, glycolipids can act as surfactants or stabilizers, facilitating the synthesis of biopolymers like cellulose, starch-based polymers, or even as additives to enhance the properties of bioplastics. In an example, glycolipids may be produced from corn steep liquor, refinery oil waste in presence of Aureobasidium thailandense, Candida lipolytica and yeast.

Optionally, the at least one biobased reactor-derived ingredient is Rhamnolipids. Rhamnolipids are typically produced by certain strains of bacteria when cultured and inoculated into the reactor. In this regard, a suitable growth medium containing carbon sources (like glucose, glycerol, or waste substrates), nitrogen sources, salts, and trace elements is used to provide the necessary nutrients for bacterial growth and rhamnolipid production. Moreover, the reactor provides controlled conditions such as temperature, pH, agitation, and aeration to optimize bacterial growth and rhamnolipid production. Rhamnolipids as surfactants typically reduce the surface tension of liquids. Moreover, rhamnolipids have emulsifying properties. In biopolymer production processes, lower surface tension and stable emulsions of hydrophobic compounds can enhance the dispersion of hydrophobic compounds in aqueous solutions or facilitate the interaction between microbial cells and compounds, resulting in improved mass transfer of nutrients and compounds, thereby promoting the growth and productivity of polymer-producing microorganisms. Additionally, rhamnolipids may contribute to biofilm formation that provide a favourable microenvironment for polymer-producing microorganisms, protecting them from environmental stresses and promoting cell-cell interactions. Thus, enhancing the stability and productivity of biopolymer production in the reactors. In other words, rhamnolipids increase compatibility of the fractions of the formulation, act as a mould release during the injection of the formulation, decrease the torque during processing thanks to the ability of acting as a slip agent. In an example, rhamnolipids may be produced from whey, molasses, frying oil in presence of Pseudomonas aeruginosa BS2, Pseudomonas aeruginosa GS3, Pseudomonas aeruginosa 47T2 4, respectively.

Beneficially, the presence of surfactants or biosurfactants enables stabilizing emulsions and allows the creation of biobased and home compostable foam. Additionally, beneficially, the biosurfactants can increase both the compatibility of the hydrophilic at least one hydrocolloid and the hydrophobic biobased biodegradable polymer.

Optionally, the biosurfactant is in a range of 0.1% to 25% of the total weight of the at least one biobased reactor-derived ingredient.

Optionally, the biosurfactant is present in a range of 0.1% to 1%, 0.1% to 5%, 0.1% to 10%, 0.1% to 15%, 0.1% to 20%, 0.1% to 25%, 1% to 5%, 1% to 10%, 1% to 15%, 1% to 20%, 1% to 25%, 5% to 10%, 5% to 15%, 5% to 20%, 5% to 25%, 10% to 15%, 10% to 20%, 10% to 25%, 15% to 20%, 15% to 25%, 20% to 25%.

It may be appreciated that the remaining concentration of the at least one biobased reactor-derived ingredient, i.e., 5% to 50% of the at least one biobased reactor-derived ingredient comprises other types of biobased reactor-derived ingredients and/or biobased non-reactor derived ingredients that may be introduced additionally into the reactor.

Optionally, the at least one biobased reactor-derived ingredient may include, but not limit to, a water-soluble microbial mucin, fungal or bacterial hydrophobins, hydrophobic polysaccharides. Typically, the water-soluble microbial mucin, fungal or bacterial hydrophobins, hydrophobic polysaccharides are typically produced through biotechnological processes involving microbial fermentation or other similar methods. The water-soluble microbial mucin is derived from microbial sources, such as bacteria or fungi. Optionally, water-soluble microbial mucin may be for example natto mucin which includes fructan, fructose and γ-polyglutamic acid (PGA). Notably, fructan and fructose are carbohydrates commonly found in plants, while PGA is a polymer composed of glutamic acid residues, often produced by bacteria such as Bacillus subtilis. The fungal and/or bacterial hydrophobins are proteins produced by fungi and some bacteria, respectively. The hydrophobins are molecules which increase the hydrophobicity of a given overall construct and may self-assemble at hydrophobic-hydrophilic interfaces. Therefore, the hydrophobins also expand on the applications of the algal-based extrudable compostable formulation and may find use in various applications, including in food and pharmaceutical industries. Hydrophobic polysaccharides, such as emulsan, are produced by certain bacteria. Notably, hydrophobic polysaccharides have emulsifying properties, making it useful in various applications, particularly in the food industry.

Optionally, the at least one biobased reactor-derived ingredient is the biobased biodegradable polymer. Optionally, the at least one biobased reactor-derived ingredient is preferably a polyester produced in a reactor. Notably, the biobased biodegradable polymer is a reactor-derived polymer, such as a polyester, i.e., which is processed in the reactor to obtain a different functionality thereof under different process conditions of the reactor. In this regard, the reactors provide controlled environments with precise regulation of factors like temperature, pH, and nutrient composition. This enables consistent, year-round production, increased yields, and tailored properties of the at least one biobased reactor-derived ingredient. Optionally, the at least one biobased reactor-derived ingredient can be created with a fossil raw material or synthetic material in addition to a biobased material, as is the case with PBS. Optionally, the latter material is obtained by chemical reaction of biobased media and ingredients in a bioreactor or reactor. Optionally, the reactor reproduces a chemical process which occurs naturally to improve yield, speed, purity and so forth; as is the case for the alkali treatment of Eucheuma species to turn the remaining precursor mu and nu carrageenan in the seaweed into kappa and iota carrageenan to increase overall extraction yields and final product gel strength. In an example, a first type of PHA may be used in the reactor to provide strength to the algal-based extrudable compostable formulation and a second type of PHA which has been enzymatically degraded in the reactor may be used to act as a ‘plasticiser and compatibilizer’ for enhancing the overall efficacy of the algal-based extrudable compostable formulation.

Optionally, the latter material is selected entirely or extracted or collected from: plants, algae, fungi, mycelium, microorganism and microbes; all of which are to be grown and multiplied with the support of a biobased media. Plants offer structural elements, energy sources, and bio-oils. Algae provide hydrocolloids, plus fatty acids, proteins, and more. Fungi contribute chitin, glucans, and versatile enzymes. Microbes deliver bacterial cellulose, bioplastics, enzymes, and bio-chemicals. Optionally, the algae may include, but is not limited to hydrocolloids, like fatty acids, proteins.

Optionally, the at least one biobased reactor-derived ingredient is a bacterial cellulose. Beneficially, the bacterial cellulose improves the strength of the overall algal-based extrudable compostable formulation.

Optionally, besides the biosurfactants, the other types of biobased reactor-derived ingredients, such as the water-soluble microbial mucin, fungal or bacterial hydrophobins, hydrophobic polysaccharides, the biobased biodegradable polymer, and/or the bacterial cellulose, is in a range of 1-5% of the 5% to 50% of at least one biobased reactor-derived ingredient. Optionally, the other types of biobased reactor-derived ingredients, other than the biosurfactants, may be in a range of 1% to 2%, 1% to 3%, 1% to 4%, 1% to 5%, 2% to 3%, 2% to 4%, 2% to 5%, 3% to 4%, 3% to 5%, 4% to 5% of the at least one biobased reactor-derived ingredient.

In an example, the at least one biobased reactor-derived ingredient comprises 50% of the total algal-based extrudable compostable formulation, wherein the 50% of the at least one biobased reactor-derived ingredient comprises 25% biosurfactant, 5% water-soluble microbial fungal 3% hydrophobins, 2% hydrophobic polysaccharides, 10% biobased biodegradable polymer, and 5% bacterial cellulose.

Optionally, the algal-based extrudable compostable formulation further comprises fibres in a range of 1% to 25% of the total weight of the algal-based extrudable compostable formulation. In this regard, the fibres are present in a range of 1% to 10%, 1% to 15%, 1% to 25%, 5% to 10%, 5% to 15%, 5% to 25%, 15% to 25%. Examples of the fibres include, but are not limited to, cellulose fibres, hemicellulose fibres, Microcrystalline cellulose (MCC).

Optionally, the fibres are cellulose fibres, and wherein the cellulose fibres are present in a range of 1% to 35% of the total weight of the algal-based extrudable compostable formulation. In this regard, the cellulose fibres are present in a range of 1% to 10%, 1% to 25%, 1% to 35%, 5% to 10%, 5% to 25%, 5% to 35%, 15% to 25%, 15% to 35%. In this regard, the cellulose fibres may be isolated using bacterial biosynthesis. In an example, the cellulose fibres may be present in a range of 1% to 5% of the total weight of the algal-based extrudable compostable formulation. Presence of the cellulose fibres in the aforesaid range significantly compromise overall tensile strength of a final material (for example, a material manufactured by extrusion of the algal-based extrudable compostable formulation in the extruder) by impeding interactions between hydrocolloid units in the algal-based extrudable compostable formulation. However, it may produce a positive impact on a rate of filament fragmentation and/or degradation thereby exponentially increasing rate of material biodegradation. In another example, the cellulose fibres may be present in a range of 10% to 35% of the total weight of the algal-based extrudable compostable formulation. Adding the cellulose fibres in the aforesaid range may impart a positive charge to the hydrocolloid units of the algal-based extrudable compostable formulation and can significantly enhance the usability of the algal-based extrudable compostable formulation.

Optionally, the algal-based extrudable compostable formulation further comprises fillers in a range of 0.1% to 20% of the total weight of the algal-based extrudable compostable formulation. In this regard, the fillers are present in a range of 0.1% to 3%, 0.1% to 6%, 0.1% to 9%, 0.1% to 12%, 0.1 to 15%, 0.1 to 18%, 0.1 to 20%, 1% to 3%, 1% to 6%, 1% to 9%, 1% to 12%, 1 to 15%, 1 to 18%, 1 to 20%, 3% to 7%, 3% to 9%, 3% to 12%, 3 to 15%, 3 to 18%, 3 to 20%, 6% to 9%, 6% to 12%, 6 to 15%, 6 to 18%, 6 to 20%, 9% to 12%, 9 to 15%, 9 to 18%, 9 to 20%, 12 to 15%, 12 to 18%, 12 to 20%, 15 to 18%, 15 to 20%, 18% to 20%. Examples of the fillers include, but are not limited to, minerals, titanium dioxide (TiO₂), Silicon dioxide (SiO₂), Aluminum oxide (Al₂O₃), clays, organoclays, carbon black, micas, talc pigments such as magnesium silicate, antioxidants, carbonates, processing aids such as flame retardants. Advantageously, the technical effect of the fillers is that they can act as inter-polymeric chain spacers to improve flowability, processability, and flexibility of the algal-based extrudable compostable formulation.

Optionally, the algal-based extrudable compostable formulation further comprises additives such as, but not limited to, flame retardants, anti-odor agents, anti-clogging agents, flowing agents, or similar. Optionally, the additives are present in a range of 0.5%-15% of the total weight of the algal-based extrudable compostable formulation. Optionally, the additives are present in a range of 0.5% to 6%, 0.5% to 10%, 0.5% to 13%, 0.5% to 15%, 1% to 6%, 1% to 10%, 1% to 13%, 1% to 15%, 5% to 10%, 5% to 13%, 5% to 15%, 10% to 15%.

Optionally, the algal-based extrudable compostable formulation further comprises amphiphiles. Optionally, the amphiphiles can be compatibilizers. The compatibilizers act on the blend by covalently bonding ingredients of differing properties such as charge, hydrophilicity. These amphiphiles can also include rheology modifiers, slip agents, anti-block agents and other non-covalent-inducing species which help the ingredients become more compatible and thus create a more homogeneous blend. The amphiphiles can be, but are not limited to, block copolymers, biobased amides, stearates. Optionally, the amphiphiles are present in a range of 0.1%-15% of the total weight of the algal-based extrudable compostable formulation. Optionally, the amphiphiles are present in a range of 0.1% to 1%, 0.1% to 2.5%, 0.1% to 5%, 0.% to 7.5%, 0.1% to 10%, 0.1% to 15%, 1% to 2.5%, 1% to 2.5%, 1% to 5%, 1% to 7.5%, 1% to 10%, 1% to 15%, 2.5% to 5%, 2.5% to 7.5%, 2.5% to 10%, 2.5% to 15%, 5% to 7.5%, 5% to 10%, 5% to 15%, 7.5% to 10%, 7.5% to 15%, 10% to 15%. The amphiphiles are added to ensure homogeneous mixing, plasticizing, dispersion of the algal-based extrudable compostable formulation.

Beneficially, the algal-based extrudable compostable formulation is biobased, food safe as accredited by the European Food and Safety Authority (EFSA) and Food and Drug Administration (FDA) standards, and at least industrially compostable and preferably home compostable. Optionally, the algal-based extrudable compostable formulation is biodegradable. Therefore, products manufactured using the algal-based extrudable compostable formulation can be easily degraded in industries and/or in homes. Further, the algal-based extrudable compostable formulation is cost-friendly, chemically harmless, and safe to use. More beneficially, the algal-based extrudable compostable formulation has extrudable properties which makes it suitable to be used with the extruder. The algal-based extrudable compostable formulation has thermoplastic-like and melt-like rheology properties which makes it suitable for use with an extruder, and can be efficiently extruded in the extruder without causing formation of clogs, formation of bubbles due to blistering being unfavorable, and over-heating in the extruder. The algal-based extrudable compostable formulation can be utilized to manufacture various products with various mechanical textures, such as being flexible, semi-rigid, rigid, rubbery, brittle, hard and soft. Examples of the products include, but are not limited to, packaging for edible items, packaging for inedible items, disposable or reusable products, degradable leather, cutlery, furniture, class 1 medical devices or similar. Optionally, the algal-based extrudable compostable formulation is dense which results in imparting strength and robustness to the products manufactured using the same. Optionally, the algal-based extrudable compostable formulation can also benefit from a foaming process due to one or more additives in the formulation that create gas during the extrusion process.

A second aspect of the invention provides a biobased and compostable material comprising an algal-based extrudable compostable formulation of the first aspect, wherein the biobased and compostable material is obtained upon extrusion of the algal-based extrudable compostable formulation. In this regard, the term “compostable material” refers to a material that can be broken-down in industries and/or in homes as per standards, such as in industries at 58 degrees Celsius as per EN13432 standard, ASTM D6400 standard, or in homes as per the EN17427 standard and NFT51 standard. Privately owned certification companies, which have market wide approval and near monopolies, also tend to follow the aforementioned standards. The term “extrusion” refers to a process in which the algal-based extrudable compostable formulation undergoes deformation by application of a force causing the algal-based extrudable compostable formulation to flow through an orifice. The algal-based extrudable compostable formulation is extrudable using any extruder. As an example, the extruder may be a screw extruder. As another example, the extruder may be a twin-screw extruder. Optionally, the twin-screw extruder provides a more homogeneous algal-based extrudable compostable formulation. Optionally, screws in the twin-screw extruder are straight, parallel and co-rotating. Further a first mixing recipient or process can also be used to pre-prepare batches. The algal-based extrudable compostable formulation is extrudable at an optimal speed to form the biobased and compostable material. As an example, the optimal speed may lie in a range of 50 rpm to 1000 rpm. Optionally, the algal-based extrudable compostable formulation exits the output at a room temperature and room humidity environment. Beneficially, the biobased and compostable material has high biodegradability, high mechanical strength, high barrier properties, tunable mechanical toughness, rigidity, strength, elasticity and ductility as well as tunable water, oil and oxygen barrier properties. Moreover, the biobased and compostable material has high tensile strength, antimicrobial properties, and has high shelf-life. Owing to the aforesaid properties, the biobased and compostable material can be effectively used for manufacturing various products such as, but are not limited to, packaging material, bio leather, solid parts, disposable and reusable material.

Optionally, the biobased and compostable material is in a form of any of: a pellet, a flat band, a profiled strand, a film, a filament, a tube. In this regard, when the algal-based extrudable compostable formulation is extruded using the extruder, the biobased and compostable material may be obtained in the aforesaid forms owing to various shapes of the nozzle. In a first implementation, the biobased and compostable material may be obtained in the form of the pellet. Optionally, the pellet is micronized to form a powder. The biobased and compostable material in a powdered form may be utilized for various applications. In a second implementation, the biobased and compostable material may be obtained in the form of the flat band. Optionally, the flat band may be processed further to manufacture various products. In a third implementation, the biobased and compostable material may be obtained in the form of the profiled strand. In a fourth implementation, the biobased and compostable material may be obtained in the form of the film. In a fifth implementation, the biobased and compostable material may be obtained in the form of the filament.

Optionally, the biobased and compostable material is reprocessable using at least one manufacturing technique, the at least one manufacturing technique being at least one of: extrusion, injection moulding, film blowing, die casting, hot pressing, cold pressing, thermoforming, vacuum forming, 3D printing. In this regard, the biobased and compostable material in the form of any one of: the pellet, the flat band, the profiled strand, the film, the filament can be reprocessed to form various products using the aforesaid techniques. As an example, the biobased and compostable material may be processed to form films for packaging using the manufacturing technique of film blowing or film extrusion slot die casting. Advantageously, the technical effect of employing the aforesaid manufacturing techniques is that the biobased and compostable material may be easily and optimally utilized to manufacture desirable products.

Optionally, the biobased and compostable material is implemented as a bio-leather. In this regard, the bio-leather may be manufactured by reprocessing the flat band coming out of the output of the extruder when the flat band is hot and malleable. Optionally, the biobased and compostable material in the form of the flat band is pressed to form the bio-leather. As an example, the flat band may be pressed on a woven fabric to make the bio-leather. As another example, the flat band may be pressed on a non-woven fabric to make the bio-leather. Optionally, the bio-leather is embossed and/or covered with a hydrophobic or functionalizing layer.

A third aspect of the present invention provides a method of manufacturing a biobased and compostable material of the aforementioned second aspect, the biobased and compostable material comprising an algal-based extrudable compostable formulation of the aforementioned first aspect, the method comprising:
feeding, into an extruder,
   at least one hydrocolloid that is extracted from algae, wherein the at least one hydrocolloid is present in a range of 30% to 80% of a total weight of the algal-based extrudable compostable formulation;
   at least one plasticizer, wherein the at least one plasticizer is present in a range of 20% to 70% of the total weight of the algal-based extrudable compostable formulation;
   at least one biobased biodegradable polymer, wherein the at least one biobased biodegradable polymer is derived from at least one cultivated biomass, and wherein the at least one biobased biodegradable polymer is present in a range of 5% to 80% of a total weight of the algal-based extrudable compostable formulation; and
   at least one biobased reactor-derived ingredient, wherein the at least one biobased reactor-derived ingredient is present in a range of 5% to 50% of a total weight of the algal-based extrudable compostable formulation,
   wherein the at least one biobased reactor-derived ingredient is at least a biosurfactant produced in a reactor,
while operating the extruder at a temperature lying in a range of 60 degrees Celsius to 190 degrees Celsius; and
collecting the biobased and compostable material from an output of the extruder.

In this regard, optionally, the extruder is the screw extruder. Examples of the screw extruder include, a single screw extruder, the twin screw extruder. The screw extruder comprises a back feeder and one or more front feeders. The term “feeder” refers to an input of material of the screw extrusion machine. The aforesaid constituents are fed to the extruder via the back feeder and the one or more front feeder. Optionally, the back feeder is present opposite to the output and the one or more front feeder is present between the back feeder and the output. Optionally, one of the one or more front feeder is used to feed temperature and or shear insensitive material and another front feeder (positioned near the output) of the one or more front feeder is used to feed temperature and or shear sensitive material so that the sensitive constituents can be blended but do not get damaged due to heat and or shear in the extruder. Examples of the insensitive material could be fillers, thermoplastic, or similar. Examples of the temperature and or shear sensitive material could be, organic fibers, flame retardants, antimicrobial compounds, antioxidants, or similar. As an example, the at least one hydrocolloid in powdered form with the at least one plasticizer may be added to the extruder from the back feeder and the PBS may be added to the extruder from the one or more front feeder. In said example, the at least one plasticizer may be added or fed before the at least one hydrocolloid so as to coat at least one screw of the extruder to avoid flashing, clumping and degradation of the at least one hydrocolloid by preventing direct contact with the at least one screw. Optionally, the rate at which the at least one hydrocolloid and the at least one plasticizer are fed to the extruder depends upon a size of the extruder. The extruder having a larger size results in a greater feed rate, and vice versa. Optionally, the rate at which the at least one hydrocolloid and the at least one plasticizer are fed to the extruder lies in a range of 15% to 100% of maximum feed rate of the extruder. As an example, depending on the size and motor power of the extruder, the at least one hydrocolloid and the at least one plasticizer may be fed to the extruder at a rate of 0.1 Kg/hour to 100 Kg/hour. The feed rate of the at least one hydrocolloid, and the at least one plasticizer into the extruder depends upon scalability of the extruder. The feed rate of the at least one hydrocolloid, and the at least one plasticizer into the extruder is comparatively less at laboratory scale then at manufacturing scale. As an example, the at least one hydrocolloid may be fed at the rate of 2.04 kg/hour to 3.3 kg/hour at the laboratory scale. As another example, the at least one plasticizer may be fed at the rate of 0.828 kg/hour to 1.68 kg/hour at the laboratory scale. As yet another example, the at least one biobased biodegradable polymer may be fed at the rate of 0.231 kg/hour to 1.656 kg/hour at the laboratory scale. Optionally, the at least one plasticizer may be fed at the rate of 20 kg/hour to 50 kg/hour at the pilot scale. Optionally, the at least one plasticizer may be fed at the rate of 100 kg/hour to 1000 kg/hour at the commercial scale. Further, it will be noted that the feed rate of at least: the at least one hydrocolloid, and the at least one plasticizer into the extruder may also depend upon, screw profile, diameter of the screw, Length to diameter (L/D) ratio of the screw, inner diameter to outer diameter ratio (ID/OD) of the screw, surface area of the nozzle, presence of a vacuum and or a gear pump, and setting of the extruder. Optionally, some of the aforesaid parameters determine free volume of the extruder capable of holding the homogeneous mixture. Optionally, the addition points for different components in the extruder depend on the specific process and the type of extruder being used. Optionally, the aforesaid parameters determine the free volume of a mixing vessel of the extruder.

Optionally, the extruder comprises one or more kneading zones. Optionally, the extruder requires mechanical input/energy, the tuning of the screw profile, barrel length, rpm, order of addition, Hildebrand parameters, rheology matching, and so forth. The one or more kneading zones are located between the back feeder and the output of the extruder. The one or more kneading zones include one or more mixing elements. The mixing elements are at least one of: dispersive mixing elements, distributive mixing elements. The one or more kneading zones are employed to facilitate homogeneous mixing or plasticization from the biobased and compostable material. As an example, the extruder includes three kneading zones. A first kneading zone may have distributive mixing elements and dispersive mixing elements. A second kneading zone may have dispersive mixing elements to disperse materials coming from the one or more front feeder. A third kneading zone may have distributive mixing elements and dispersive mixing elements. Optionally, the extruder screw profile comprises other standard or tailored elements to enable or enhance the extrudability and quality of the formulation, such as reverse transport elements, flow splitters or stoppers.

Optionally, the extruder is operated at the temperature lying in a range of 60 degrees Celsius to 90 degrees Celsius, 60 degrees Celsius to 130 degrees Celsius, 60 degrees Celsius to 160 degrees Celsius, 60 degrees Celsius to 190 degrees Celsius, 80 degrees Celsius to 130 degrees Celsius, 80 degrees Celsius to 160 degrees Celsius, 80 degrees Celsius to 190 degrees Celsius, 100 degrees Celsius to 130 degrees Celsius, 100 degrees Celsius to 160 degrees Celsius, 100 degrees Celsius to 190 degrees Celsius, 140 degrees Celsius to 140 degrees Celsius, 140 degrees Celsius to 190 degrees Celsius. It will be appreciated that the extruder is operated at the temperature lying in a range of +/−20 degree Celsius of a highest melting point of one of the constituents of the algal-based extrudable compostable formulation. Alternatively, the extruder is operated at the temperature lying in a range of +/−20 degree Celsius of a highest glass transition temperature or a highest degradation temperature of one of the constituents of the algal-based extrudable compostable formulation. Optionally, an order in which the aforesaid constituents of the algal-based extrudable compostable formulation are fed to the extrusion machine and the temperature at which the feeding is performed is crucial to ensure required extrudability of the algal-based extrudable compostable formulation.

Further, extrusion of the algal-based extrudable compostable formulation results in the manufacturing of the biobased and compostable material. In this regard, the output is in the form of one of: a nozzle, a head, a die. As an example, the output may be a round hole resulting in obtaining the biobased and compostable material in a form of the filament. As another example, the output may be flat bands resulting in obtaining the biobased and compostable material in a form of the film. Further, the biobased and compostable material may be collected from the output of the extruder in a suitable collection element, such as a tray. Optionally, the biobased and compostable material is received on one of: a conveyer, a roller. Optionally, the biobased and compostable material received on one of: the conveyer, the roller is subjected to palletization for reprocessing. As an example, in case of the output in the form of a slot die, the film of the biobased and compostable material is reprocessed using a calendaring system. Optionally, the biobased and compostable material is directly cut in pellets with a head mounted piece and is transported by mechanical action or fluids directly to a point of collection for drying or packing. Optionally, the head mounted piece comprises a drying part and an air or liquid cooling part.

Optionally, the extruder comprises at least one screw, and wherein when operating the extruder, the at least one screw is rotated at a speed of 50-500 rotations per minute (RPM). In this regard, the at least one screw is rotated at a speed of 10 RPM to 100 RPM, 10 RPM to 200 RPM, 10 RPM to 250 RPM, 10 RPM to 300 RPM, 10 RPM to 500 RPM, 10 RPM to 750 RPM, 10 to 1000 RPM, 20 RPM to 100 RPM, 20 RPM to 200 RPM, 20 RPM to 250 RPM, 20 RPM to 300 RPM, 20 RPM to 500 RPM, 20 RPM to 750 RPM, 20 to 1000 RPM, 50 RPM to 100 RPM, 50 RPM to 200 RPM, 50 RPM to 250 RPM, 50 RPM to 300 RPM, 50 RPM to 500 RPM, 50 RPM to 750 RPM, 50 to 1000 RPM, 100 RPM to 200 RPM, 100 RPM to 250 RPM, 100 RPM to 300 RPM, 100 RPM to 500 RPM, 100 RPM to 750 RPM, 100 to 1000 RPM, 200 RPM to 300 RPM, 200 RPM to 500 RPM, 200 RPM to 750 RPM, 200 to 1000 RPM, 300 RPM to 750 RPM, 300 to 1000 RPM, 500 RPM to 750 RPM, 500 to 1000 RPM, 750 RPM to 1000 RPM. Optionally, the at least one screw has the length to diameter ratio (L/D) of approximately 45 and inner diameter to outer diameter ratio (ID/OD) ratio of approximately 1.6. A number of the at least one screw may depend upon application. As an example, the extruder may comprise two screws. The at least one screw is employed to force the algal-based extrudable compostable formulation to pass towards the output of the extruder to come out of the output in an extruded form. Optionally, the screw extruder also comprises a system to heat the barrel of the extruder and motors. Further, torque of the screw is also maintained at a suitable value. For example, for the single screw extrusion machine, the torque may be 90% in value. As another example, for the twin screw extruder, the torque may be 40% in value. Preferably, the torque lies in the range of 65% to 85% in value as this beneficially translates that the motor is being used at full capacity without endangering the gearbox, thus resulting in higher energy efficiency.

In an exemplary implementation, the at least one hydrocolloid in powder form is added to the extruder along with semi-refined material, which is rich in fibres etc., in varying size ranges. Besides, the semi-refined material, Talc or CaCO₃ or other fillers may be added and the mixture is dispersed using a mixer unit. Subsequently, a process enhancer material is added in the side port of the extruder (this is usually a 7% fraction of home compostable bioplastic or it could be also a biobased surfactant potentially). This is usually in pellet form. Then sensitive materials (temperature and shear sensitive) are added at the end of the extruder.

In another exemplary implementation, in a first stage, a base material (i.e., the at least one hydrocolloid and the at least one plasticiser mixture) is extruded into pellets form. In a second stage, the at least one hydrocolloid and the at least one plasticiser mixture pellets are mixed with the at least one biobased biodegradable polymer pellets and at least one biobased reactor-derived ingredient is introduced into the extruder to make the final blend.

Optionally, the method further comprises arranging at least one of: a shaping device, a cutting device at the output of the extruder, for enabling the biobased and compostable material to be obtained in a form of any of: a pellet, a flat band, a profiled strand, a film, a filament. The term “output” refers to an end of the extruder through which the algal-based extrudable compostable formulation is obtained in the form of any of: the pellet, the flat band, the profiled strand, the filament. Optionally, the cutting device is implemented as a rotatory cutter. In this regard, a filament of the algal-based extrudable compostable formulation may be cut into pellets using the rotatory cutter or a water/air cutter placed directly on the head of the extruder. Advantageously, the technical benefit of employing the shaping and the cutting device is that the biobased and compostable material is easily obtained in a required form for future use.

Optionally, the method is implemented as a two-step method comprising recompounding the at least one hydrocolloid with the at least one biobased biodegradable polymer. Notably, recompounding likely involves some form of processing or mixing to modify the properties or composition of the at least one hydrocolloid before it is combined with the at least one biobased biodegradable polymer. Herein, the at least one hydrocolloid is obtained or compounded in form of a pellet in a first step. In a second step, the pellet form of the at least one hydrocolloid is recompounded with the at least one biobased biodegradable polymer to obtain a pellet form of the composition comprising the at least one hydrocolloid and the at least one biobased biodegradable polymer, along with other components of the biobased and compostable material.

Optionally, the method further comprises arranging at least one cooling machine at the output of the extruder, to maintain temperature and humidity conditions of the environment in which the biobased and compostable material is obtained. Examples of the cooling machine include, but are not limited to, swamp coolers, air-cooled heat exchangers, air-cooled industrial chillers.

Optionally, the method further comprises arranging at least one ventilation system in the barrel of the extruder. The at least one ventilation system prevents gases from mixing with the algal-based extrudable compostable formulation, resulting in less pressure and prevention of formation of bubbles or blisters at the output of the extruder. Optionally, the method further comprises arranging at least one pump between an end of the at least one screw and the output. Optionally, the at least one pump is arranged to generate required pressure at the output.

### Experimental Data for the Algal-Based Extrudable Compostable Formulation:

The algal-based extrudable compostable formulation comprising the PHA in a range of 2% to 35% as the at least one biobased biodegradable polymer, organic starch in a range of 10% to 40% as the at least one polysaccharide, TiO₂ in a range of 0.1% to 5% as fillers and 10%-40% of glycerol as at least one plasticizer was prepared. It was observed that said algal-based extrudable compostable formulation was efficiently extruded using a twin-screw extruder having a diameter of 16 mm and a length to diameter ratio of 40 mm. The twin screw extruder is operated at the temperature lying in a range of 80 degree Celsius to 140 degree Celsius and screws are rotated at a speed of 50-500 RPM. The aforesaid algal-based extrudable compostable formulation was extruded to form films, pellets, filaments having high mechanical strength and being reprocessable by means of conventional thermoplastic machinery.

The algal-based extrudable compostable formulation comprising 80% of a base mixture and 20% of the PBAT/PBS/PLA/PHA in the form of pellet was prepared, wherein the base mixture comprises 60% of the at least one Hydrocolloid and 40% of the at least one plasticizer in a form of pellet. It was observed that said algal-based extrudable compostable formulation was efficiently extruded using the extruder. Said algal-based extrudable compostable formulation was efficiently extruded using a twin screw extruder at a temperature of 120 degree Celsius.

The algal-based extrudable compostable formulation comprising 55-75% of the at least one hydrocolloid and 5%-35% of PBS was prepared. In said formulation, the PBS acts as the at least one plasticizer.

The algal-based extrudable compostable formulation comprising of hydrocolloid, PBS, starch and glycerol was prepared. The aforesaid constituents were blended in a ratio of 50:8:12:30. It was observed that said algal-based extrudable compostable formulation was efficiently extruded using the extruder and processed to form flexible packaging. In said formulation, the PBS may be replaced by PHA, PBAT and PLA.

The algal-based extrudable compostable formulation comprising 40% of the at least one hydrocolloid, 25% of the biomass (agricultural waste, bacterial biomass and fungal biomass), 35% of the glycerol was prepared and fed to the extruder. The extruder was operated at the temperature lying in a range of 60 degree Celsius to 140 degree Celsius. The screw of the extruder was rotated at the speed of 50 RPM to 350 RPM. It was observed that the said algal-based extrudable compostable formulation was efficiently extrudable using the extruder.

The algal-based extrudable compostable formulation comprising 50% of the at least one hydrocolloid, 15% of algal biomass and 35% of the glycerol was prepared. It was observed that the said algal-based extrudable compostable formulation was efficiently extrudable using the extruder operated at a temperature lying in a range of 60 degrees Celsius −140 degrees Celsius, with the screw of the extruder being rotated at 50-350 rpm.

### Experimental Data for the Method of Manufacturing the Biobased and Compostable Material at the Laboratory Scale:

The biobased and compostable material was manufactured by feeding a mixture of the agar and the carrageenan at the rate of 35 g/min to 45 g/min in the back feeder, the glycerol at the rate of 20 g/min to 30 g/min in the front feeder at the temperature of 125 degree Celsius and the PBS was fed at the rate of 3.5 g/min to 5.5 g/min in the front feeder at a room temperature in a single screw extruder. The screw was rotated at the rate of 240 RPM. The biobased and compostable material was obtained in the form of the filament.

The biobased and compostable material was manufactured by feeding a mixture of the agar and the carrageenan at the rate of 35 g/min to 45 g/min in the back feeder and the at least one plasticizer at the rate of 20 g/min to 30 g/min in the front feeder at the temperature of 135 degree Celsius. The screw was rotated at the rate of 150 RPM.

The biobased and compostable material was manufactured by feeding a mixture of the agar and the carrageenan at the rate of 35 g/min to 45 g/min in the back feeder, the at least one plasticizer was fed at the rate of 20 g/min to 30 g/min in the front feeder at the temperature of 65 degree Celsius, the at least one biobased biodegradable polymer was fed at the rate of 4 g/min to 8 g/min in the front feeder at the room temperature in the single screw extruder. Further, TiO₂ was added at the rate of 0.1 g/min to 1 g/min and was added at the rate of 1 g/min to 5 g/min. The screw was rotated at the rate of 200 RPM. The natural color was imparted by the microalgae, plant, seaweed and extract from the same.

The biobased and compostable material was manufactured by feeding a mixture of the agar and the carrageenan at the rate of 35 g/min to 45 g/min in the back feeder, the glycerol at the rate of 20 g/min to 30 g/min at the front feeder at the temperature of 65 degree Celsius, the PBS was added at the rate of 3.5 g/min to 5.5 g/min in the front feeder at the room temperature in the single screw extruder. The screw was rotated at the rate of 200 RPM.

The biobased and compostable material was manufactured by feeding a mixture of the agar and the carrageenan at the rate of 35 g/min to 45 g/min in the back feeder, the at least one plasticizer was fed at the rate of 20 g/min to 30 g/min in the front feeder at the temperature of 65 degree Celsius and the biomass was added at the rate of 3 g/min 10 g/min in the single screw extruder. The screw was rotated at the rate of 200 RPM.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 illustrates steps of a method for manufacturing a biobased and compostable material, in accordance with an embodiment of the present disclosure;

FIG. 2 illustrates an exemplary overall process for manufacturing a biobased and compostable material, in accordance with an embodiment of the present disclosure; and

FIGS. 3A and 3B are illustrations of an extruder, in accordance with different embodiments of the present disclosure.

### DETAILED DESCRIPTION

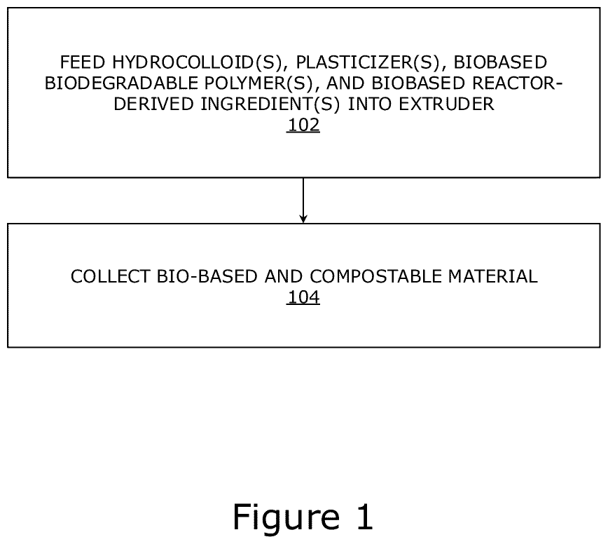

Referring to FIG. 1, illustrated are steps of a method for manufacturing a biobased and compostable material comprising an algal-based extrudable compostable formulation, in accordance with an embodiment of the present disclosure. At step 102, at least one hydrocolloid, at least one plasticizer, at least one biobased biodegradable polymer, and at least one biobased reactor-derived ingredient, in a range of 30% to 80%, 20% to 70%, 1% to 80%, and 5% to 50% of a total weight of the algal-based extrudable compostable formulation, respectively, are fed into an extruder while operating the extruder at a temperature lying in a range of 60 degrees Celsius to 190 degrees Celsius. At step 104, the biobased and compostable material from an output of the extruder is collected.

The aforementioned steps are only illustrative, and other alternatives can also be provided where one or more steps are added, one or more steps are removed, or one or more steps are provided in a different sequence without departing from the scope of the claims herein.

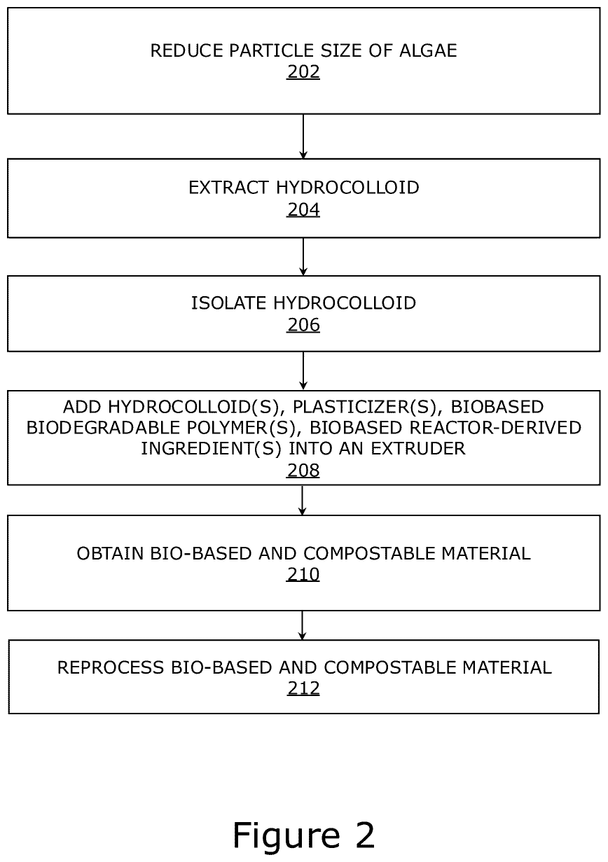

Referring to FIG. 2, illustrated is an exemplary overall process for manufacturing a biobased and compostable material, in accordance with an embodiment of the present disclosure. At 202, particle size of algae is reduced to a required size. At 204, the algae is processed to extract at least one hydrocolloid. At 206, the at least one hydrocolloid is isolated. At 208, the at least one hydrocolloid, at least one plasticizer, at least one biobased biodegradable polymer derived from at least one cultivated biomass, and at least one biobased reactor-derived ingredient is added into an extruder. At 210, a biobased and compostable material is collected from an output of the extruder. At 212, the biobased and compostable material is reprocessed.

The aforementioned steps are only illustrative, and other alternatives can also be provided where one or more steps are added, one or more steps are removed, or one or more steps are provided in a different sequence without departing from the scope of the claims herein.

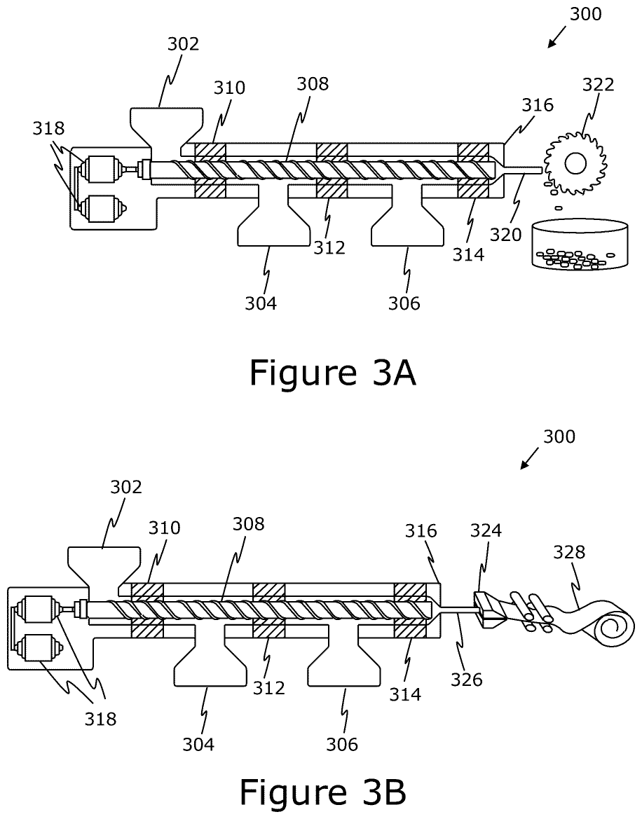

Referring to FIGS. 3A and 3B, illustrated are illustrations of an extruder 300, in accordance with different embodiments of the present disclosure. The single extruder 300 includes a back feeder 302, one or more front feeder (depicted for example, as front feeders 304 and 306), a screw 308, one or more kneading zones (depicted for example, as kneading zones 310, 312, and 314), an output 316 and motors 318. As an example, at least one hydrocolloid is fed into the extruder 300 through the back feeder 302 and at least one plasticizer is added to the extruder 300 through the front feeder 304 and biomass is added to the front feeder 306. Moreover, the at least one biobased biodegradable polymer is added at the beginning of the process, via the back feeder 302, in a range of 5-80%, or mid-way through the extruder, via the front feeder 304, in a range of 5-80%, or at the last feeding port, i.e., via the front feeder 306, in a range of 5 to 10%, and the at least one biobased reactor-derived ingredient may be added at the end of the process, i.e., via the front feeder 306, if the at least one biobased reactor-derived ingredient is a bacterial cellulose, and if the at least one biobased reactor-derived ingredient is a biosurfactant, then the same can be added to the process at the beginning, i.e., via the back feeder 302, to obtain a biobased and compostable material in a form of a filament (depicted for example as a filament 320). It may be appreciated that the at least one hydrocolloid may be fed into the extruder 300 through the front feeder 304 or 306. In FIG. 3A, a cutting element 322 is arranged at the output 316 of the extruder 300. The filament 320 is cut to obtain a biobased and compostable material in a form of pellets (depicted for example as blocks) using the cutting element 322.

In FIG. 3B, a slot die 324 is arranged at the output 316 of the extruder 300. The filament 326 is passed through the slot die 324 to obtain the biobased and compostable material in a form of a film (depicted for example, as a film 328).

FIGS. 3A and 3B are merely examples, which should not unduly limit the scope of the claims herein. A person skilled in the art will recognize many variations, alternatives, and modifications of embodiments of the present disclosure.

1-18. (canceled)

19. An algal-based extrudable compostable formulation comprising: at least one hydrocolloid that is extracted from algae, wherein the at least one hydrocolloid is present in a range of 30% to 80% of a total weight of the algal-based extrudable compostable formulation; at least one plasticizer, wherein the at least one plasticizer is present in a range of 20% to 70% of the total weight of the algal-based extrudable compostable formulation; at least one biobased biodegradable polymer, wherein the at least one biobased biodegradable polymer is derived from at least one cultivated biomass, and wherein the at least one biobased biodegradable polymer is present in a range of 5% to 80% of a total weight of the algal-based extrudable compostable formulation; and at least one biobased reactor-derived ingredient, wherein the at least one biobased reactor-derived ingredient is present in a range of 5% to 50% of a total weight of the algal-based extrudable compostable formulation, wherein the at least one biobased reactor-derived ingredient is at least a biosurfactant produced in a reactor.

20. An algal-based extrudable compostable formulation according to claim 19, wherein the at least one hydrocolloid comprises agar and carrageenan mixed in a ratio of 1:2, respectively.

21. An algal-based extrudable compostable formulation according to claim 19, wherein the at least one plasticizer comprises a composition of glycerol, water and polyglycerols and wherein glycerol comprises 0.1 to 10% of the plasticizer composition.

22. An algal-based extrudable compostable formulation according to claim 19, wherein the biosurfactant is in a range of 0.1% to 25% of the total weight of the at least one biobased reactor-derived ingredient.

23. An algal-based extrudable compostable formulation according to claim 19, wherein the at least one biobased biodegradable polymer is polyhydroxyalkanoate PHA polymer family in a range of 2% to 35% of the total weight of the algal-based extrudable compostable formulation.

24. An algal-based extrudable compostable formulation according to claim 19, wherein the polyhydroxyalkanoate PHA polymer family is in a range of 50% to 75% of the total weight of the algal-based extrudable compostable formulation.

25. An algal-based extrudable compostable formulation according to claim 19, further comprising biomass in a range of 1% to 35% of the total weight of the algal-based extrudable compostable formulation.

26. An algal-based extrudable compostable formulation according to claim 19, further comprising fibres in a range of 1% to 25% of the total weight of the algal-based extrudable compostable formulation.

27. An algal-based extrudable compostable formulation according to claim 26, wherein the fibres are cellulose fibres.

28. An algal-based extrudable compostable formulation according to claim 19, further comprising fillers in a range of 0.1% to 20% of the total weight of the algal-based extrudable compostable formulation.

29. A biobased and compostable material comprising an algal-based extrudable compostable formulation according to claim 19, wherein the biobased and compostable material is obtained upon extrusion of the algal-based extrudable compostable formulation.

30. A biobased and compostable material according to claim 19, wherein the biobased and compostable material is in the form of any of: a pellet, a flat band, a profiled strand, a filament, a tube.

31. A biobased and compostable material according to claim 29, wherein the biobased and compostable material is processable using at least one manufacturing technique, the at least one manufacturing technique being at least one of: extrusion, injection moulding, film blowing, die casting, hot pressing, cold pressing, thermoforming.

32. A biobased and compostable material according to claim 29, wherein the biobased and compostable material is implemented as a bio-leather.

33. A method of manufacturing a biobased and compostable material according to claim 29, the biobased and compostable material comprising an algal-based extrudable compostable formulation according to claim 19, the method comprising: feeding, into an extruder, at least one hydrocolloid that is extracted from algae, wherein the at least one hydrocolloid is present in a range of 30% to 80% of a total weight of the algal-based extrudable compostable formulation; at least one plasticizer, wherein the at least one plasticizer is present in a range of 20% to 70% of the total weight of the algal-based extrudable compostable formulation; at least one biobased biodegradable polymer, wherein the at least one biobased biodegradable polymer is derived from at least one cultivated biomass, and wherein the at least one biobased biodegradable polymer is present in a range of 5% to 80% of a total weight of the algal-based extrudable compostable formulation; and at least one biobased reactor-derived ingredient, wherein the at least one biobased reactor-derived ingredient is present in a range of 5% to 50% of a total weight of the algal-based extrudable compostable formulation, wherein the at least one biobased reactor-derived ingredient is at least a biosurfactant produced in a reactor, while operating the extruder at a temperature lying in a range of 60 degrees Celsius to 190 degrees Celsius; and collecting the biobased and compostable material from an output of the extruder.

34. A method according to claim 33, wherein the extruder comprises at least one screw, and wherein when operating the extruder, the at least one screw is rotated at a speed of 10 to 1000 rotations per minute (RPM).

35. A method according to claim 33, further comprising arranging at least one of: a shaping device, a cutting device at the output of the extruder, for enabling the biobased and compostable material to be obtained in a form of any of: a pellet, a flat band, a profiled strand, a filament, a tube.

36. A method according to claim 34, wherein the method is implemented as a two-step method comprising recompounding the at least one hydrocolloid with the at least one biobased biodegradable polymer.
